(19) United States
(12) Patent Application Publication
(10) Pub. No.: US 2008/0304638 A1
(43) Pub. Date: Dec. 11, 2008

(54) System and method for delivering targeted promotional announcements over a telecommunications network based on financial instrument consumer data

(75) Inventors: Richard Jackowitz, Warwick, NY (US); Mark Colyer, Wyckoff, NJ (US)

Correspondence Address: K&L Gates LLP, STATE STREET FINANCIAL CENTER, One Lincoln Street, BOSTON, MA, 02111-2950, US

(73) Assignee: Branded Marketing LLC, West Milford, NJ (US)

(21) Appl. No.: 11/810,760

(22) Filed: Jun. 7, 2007

(51) Int. Cl. H04M 1/64

(52) U.S. Cl. 379/88.25

(57) ABSTRACT

A method for delivering an announcement in a telecommunications system comprising: receiving a message including an identity of a calling party; retrieving a customer profile associated with the calling party, wherein the customer profile includes information derived from a financial account associated with the calling party; receiving from the calling party a dialed number associated with a called party; selecting an announcement from a plurality of announcements based on the customer profile; and delivering the announcement to the calling party.

### FIELD OF THE INVENTION

The present invention relates generally to providing promotional announcements over a telecommunications network and, more particularly, to providing telecommunications services in exchange for listening to an announcement.

### BACKGROUND OF THE INVENTION

Targeted promotional announcements may be used in a telecommunications system to generate additional revenue. For example, advertisers may ask consumers to listen to a promotional announcement in exchange for something of value, such as discounted or free telecommunications service for limited time. Generally, advertisers are unwilling to offer more than a couple of minutes of free or discounted telecommunications services without some assurance that the advertiser's announcement was delivered to an appropriate group of consumers or that the consumers listened to the announcement. Likewise, consumers are unwilling to use the service without more free or discounted minutes. Embodiments of the present invention address, among other things, these competing needs.

### SUMMARY OF THE INVENTION

Embodiments of the present invention relate to a system and method for delivering announcements over a telecommunications network. Generally, the telecommunications network plays a promotional announcement prior to connecting a calling party to a called party, wherein the promotional announcement is selected based on information derived from a financial account associated with the calling party. The calling party is then provided an opportunity to earn a period of free or discounted calling for responding correctly to a question about the content of the promotional message. The calling party may be presented with additional opportunities during the call to earn additional time units of free or discounted calling.

In one aspect of the invention, a method of making a toll-free call by a caller includes accessing a designated dial-in-number; entering a caller identifier; entering a toll call number to be called; listening to a message; providing verification that the first message was listened to; permitting the toll call connection to be completed for a preset amount of time while a time remaining is greater than zero; warning the caller before the preset amount of time expires; listening to an additional message; and adding a time unit to the time remaining.

In another aspect of the invention, a method for delivering an announcement in a telecommunications system includes: receiving a message including an identity of a calling party; retrieving a customer profile associated with the calling party, wherein the customer profile includes information derived from a financial instrument associated with the calling party; receiving from the calling party a dialed number associated with a called party; selecting an announcement from a plurality of announcements based on the customer profile; and delivering the announcement to the calling party.

### BRIEF DESCRIPTION OF THE DRAWINGS

Embodiments and other aspects of this invention will be readily apparent from the detailed description below and the attached drawings, which are meant to illustrate and not to limit the invention, wherein:

FIG. 1 is a functional block diagram that illustrates the components of an exemplary system for practicing an embodiment of the present invention; and

FIG. 2 is a process diagram of an exemplary method for practicing an embodiment of the present invention.

### DESCRIPTION

The present invention will be more completely understood through the following detailed description, which should be read in conjunction with the attached drawings. In this description, like numbers refer to similar elements within various embodiments of the present invention. The claimed invention will be explained with respect to various embodiments. However, the skilled artisan will readily appreciate that the methods and systems described herein are merely exemplary and that variations can be made without departing from the spirit and scope of the invention.

An embodiment of the present invention relates to a system and method for providing telecommunications services in exchange for listening to a promotional announcement, such as an advertisement. For example, a telecommunications network may be configured to play a promotional announcement before connecting a calling party to a called party and offer the calling party an opportunity to earn free or discounted calling for responding correctly to a question about the content of the announcement. Some embodiments identify the calling party based on a financial card and select targeted promotional announcements based on historical financial data associated with the calling party's use of the financial card. Additional embodiments, described in greater detail below, warn the calling party prior to the end of the free or discounted calling period and allow the calling party to request additional announcements to extend the free or discounted period.

In the following discussion of illustrative embodiments, the term “database,” as used in this description, may be any body of information that is logically organized so that it can be retrieved, stored and searched in a coherent manner. The term “calling party” is used in this description generally to refer to the person or unit that initiates a telecommunication. The calling party may also be referred to herein as “caller” or “subscriber.” The term “announcement,” as used herein, refers to a sound or video recording that may be played back, or “presented,” to the caller to impart information to the caller. Examples of announcements can include, but are not limited to: commercials, promotions, public service announcements (PSAs), weather alerts, news alerts, infomercials, instruction recordings, and the like. The terms “financial card” and “financial instrument” are used interchangeably herein to mean any portable object associated with a financial account including credit cards, debit cards, stored value cards, and contactless devices. Contactless devices include, but are not limited to, fobs, chip enabled smart cards, mobile transmitters, mobile devices, 2D Code readers, physical world connection readers, and radio frequency identification transmitters.

It is to be understood that the figures and descriptions of the present invention have been simplified to illustrate elements that are relevant for a clear understanding of the present invention while eliminating, for purposes of clarity, other elements. For example, certain details relating to a telecommunications network or the hardware elements installed in such a network are not described herein. A discussion of such elements is not provided because such elements are well known in the art and because they do not facilitate a better understanding of the present invention and because embodiments of the present invention may be implemented using a telecommunications service provider's existing hardware by making appropriate software upgrades.

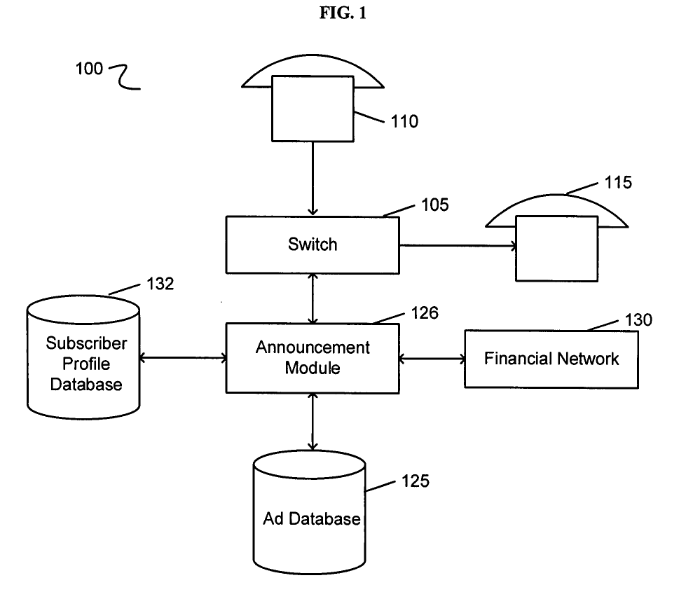

FIG. 1 is a schematic diagram of an exemplary system 100 for delivering promotional announcements over a telecommunications network according to an embodiment of the present invention. According to the illustrated embodiment, system 100 includes a switch 105 in communication with a calling party 110 and a called party 115. Switch 105 communicates with an announcement module 120 from which switch 105 may receive announcements. Announcement module 120, in turn, communicates with an ad database 125, a financial network 130, and a subscriber profile database 132. In alternative embodiments, the functions performed by one of the functional blocks illustrated in FIG. 1 may be performed by or combined with another function block. For example, announcement module 120 may perform the functions of both announcement module 120 and ad database 125.

Switch 105 may be configured to manage communications between calling party 110 and announcement module 120 and between calling party 110 and called party 115 in accordance with embodiments of the present invention. In some embodiments, switch 105 is implemented as an enhanced call router or an advanced intelligent network component, such as an SS7 network, for connecting voice channel circuits.

Announcement module 120 may be configured to control the delivery of announcements to calling party 110 according to one or more embodiments of the present invention. For example, announcement module 120 may be configured to authenticate calling party 110 as a registered subscriber, deliver announcements to calling party 110, receive and process responses from calling party 110, and direct switch 105 to connect calling party 110 to called party 115. Those skilled in the art will appreciate that announcement module 120 may be equipped with an interactive voice response (IVR) system for communicating with calling party 110. Announcement module 120 may also be adapted to maintain a log of announcements, such as by subscriber.

Ad database 125 is a searchable storage entity that may be configured to store and serve a plurality of announcements such as audio, video, text, and/or graphic format advertisements associated with participating merchants. Announcements may be sold in a block or on a “per spot” basis. A block of advertising time refers to the purchase an advertisement played a certain number of times over a defined period (e.g., an 8 week, $250,000 block). A “per spot” basis refers to the purchase of a single play of an advertisement (e.g., $0.45/spot). Spot pricing may vary based on the time of day a call is made, the total call volume within the system during that specific call, and the consumers level of participation. Advertising revenue may be used to subsidize the cost of the telephony services.

Subscriber profile database 132 is a searchable storage entity that may be configured to store a plurality of subscriber profiles. According to an embodiment, subscriber profile database 132 may include information about subscriber preferences, purchasing trends, locations, average purchase price over a certain time period (e.g., 30 days), time of year, age, and gender of the consumer, some of which may be obtained primarily from the historical financial data of a specific consumer or group of consumers. Subscriber profile database 132 may also include information about the subscriber's call history including the types of businesses the subscriber calls regularly. Consumer profiles are well known in the art and can include a wide variety of information relating to individual consumers.

Financial network 130 may include one or more external networks for sending requests, in the case credit or debit cards, to the appropriate bank or financial institution to authorize the purchase or transaction. Accordingly, users of system 100, such as calling party 110, may use financial instruments to purchase telephone services, such as additional minutes, or products and services associated the announcements.

Although embodiments of the present invention may be described in the context of a telephone connected to a telecommunications network, those skilled in the art will appreciate that other types of terminating equipment may be used. Other suitable terminating equipment may include interactive information processing systems such screen or video phones, mobile devices, Personal Digital Assistants, self-serve kiosks (video and audio), Automated Teller Machines (video and audio), web (internet) portals, V-Scratch interactive displays, self-serve entertainment and game stations, and other video devices.

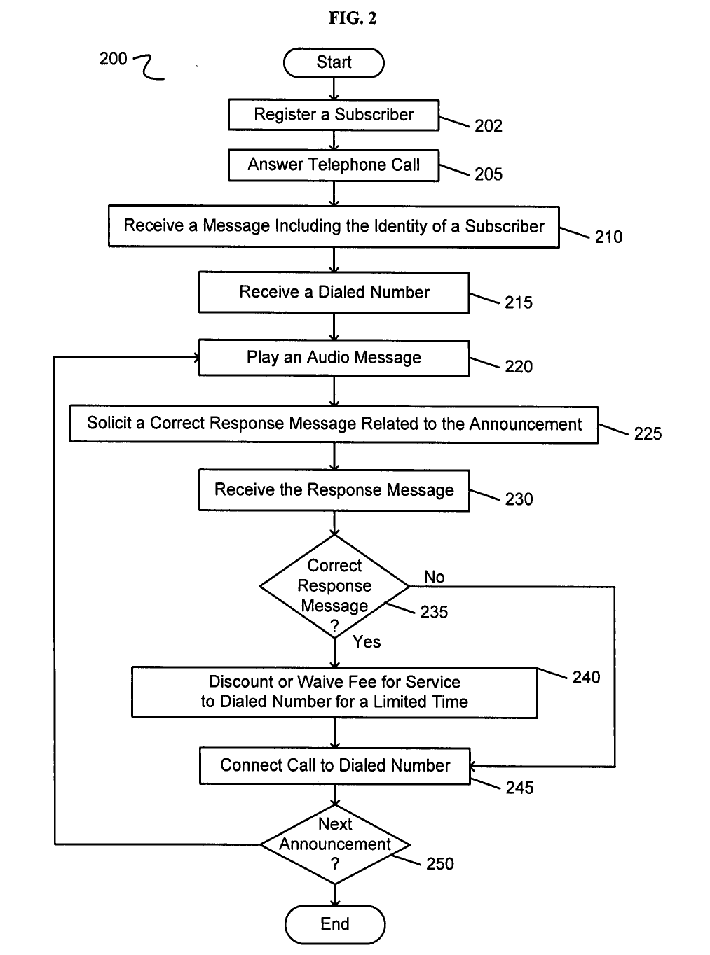

FIG. 2 is a process diagram of an exemplary method 200 for delivering promotional announcements over a telecommunications network according to an embodiment of the present invention. According to an embodiment, method 200 begins in step 202 when a subscriber registers for the services described herein. In an embodiment, step 202 may include issuing a service access directory number and access code that allows the subscriber to gain access to the telephony service provider's network. Registration services, such providing an access code, may be provided using a variety of known methods, such as via telephone, email, fax, mobile text message, web portal, mail, retail location, self-serve kiosk, or in-person. The access number may be selected by either the service provider or the user without departing from the principles of the invention.

In another embodiment, step 202 may include issuing a financial instrument to calling party 110. The financial card may be a bank association branded card including, but not limited to Visa, MasterCard, American Express, and Discover. For each purchase that calling party 110 makes, using the financial card, announcement module 120 collects and stores information about the transaction including, for example, the merchant category code (MCC) and the merchant name. In the case of a stored value card, money may be added using a variety of known methods, such as direct deposit, point of sale merchant and retail cash reload networks, participating bank branch cash reloads (such as via an automated teller machine or financial self-serve kiosk), card to card (internal system) transfers, and wire transfers.

In some embodiments, the financial card may be used to determine whether calling party 110 is generally creditworthy, such as by contacting U.S. credit bureaus and using known credit checking methods via financial network 130 or by querying a private database. For example, according to the latter embodiment, the financial card may be used to establish a repository of consumer payment history, thus establishing an internal database of spending and payment habits and trends. In some embodiments, payment habits are reviewed periodically, such as on a 120 day continuous cycle, with additional credit-line invitations being offered as appropriate. For example, if calling party 110 has no credit history or poor to below average credit, then a prepaid financial instrument may be offered, such as a stored value card. If after using the prepaid financial instrument for some period of time, such as 120 days, and third party bills are paid on time, calling party 110 may be offered an introductory line of credit.

In step 205, switch 105 receives a call from calling party 110, such as when calling party 110 dials the service access number provided in step 202 to connect to the service provider's network. According to an embodiment, calling party 110 may be connected to the Interactive Voice Response Unit (IVRU) of announcement module 120, after which the IVRU may transmit the following exemplary prompt to calling party 10: “To place a free 15 minute long distance call, press 4.” Some embodiments allow the calling party to choose a language, such as English or Spanish.

In step 210, announcement module 120 receives a message from calling party 110 that includes the identity of a subscriber. According to an embodiment, the identity of calling party 110 may be an access code or other caller identifier. The identifier may be received via a variety of input means including, but not limited to, a keypad, keyboard, magnetic strip, voice command in conjunction with a voice recognition system, or other suitable means for identifying calling party 110. In practice, the access code may be a numeric or alphanumeric code. In some embodiments, the access code may include information to identify the financial card associated with the subscriber. After approval of the access code, announcement module 120 may obtain records associated with calling party 110 from subscriber profile database 132 and present calling party 110 with a dial tone.

In step 215, announcement module 120 receives a directory number from calling party 110 that corresponds to called party 115. In some embodiments, calling party 110 is prompted to enter the directory number that he or she wishes to call. The directory number may be a domestic or international long distance number or other toll call. In some embodiments, the directory number may be stored within the service provider's network for future redialing.

In step 220, announcement module 120 delays connecting calling party 110 to called party 115 to play an announcement from ad database 125. In an embodiment, the announcement is a 15 second promotional advertisement selected at random. In other embodiments, the selection of an announcement may be based on information stored in subscriber profile database 132. This targeted information may then be used in conjunction with participating advertisers to offer targeted advertisements based on the spending habits of calling party 110. In some embodiments, announcement module 120 is configured to select announcements of local and regional advertisers based on the residential zip code and/or area code of calling party 110, a practice known as “Geo-Targeting.” Announcements played for calling party 110 may be tracked and stored, such as in subscriber profile database 132.

After the conclusion of the announcement, in step 225, announcement module 120 solicits a response message from calling party 110 related to the content of the announcement. The response message may be used to provide verification that calling party 110 listened to the announcement, which may improve the market value of the announcement. In an embodiment, calling party 110 may be asked to provide a response, via a multiple choice format, that identifies which merchant is associated with the announcement played in step 220. For example, calling party 110 may be asked to “press ‘1’ for Wal-Mart, press ‘2’ for T-Mobile, press ‘3’ for H&R Block.” According to an embodiment, calling party 110 may be prompted to press # (pound) to opt out of the exchange and, for example, go directly to step 245 below. According to another embodiment, if no response is received from calling party 110 within a predetermined period of time, or if an incorrect response is received, switch 105 begins normal call processing by connecting calling party 110 to called party 115 and bill for the minutes of use.

In step 230, announcement module 120 receives the response message from calling party 110 and, in step 235, determines whether calling party 110 provided a correct response. If calling party 110 responds correctly, calling party 110 may be offered cash, credit, prizes, or other means for transferring value. For example, calling party 110 may receive an entry into a sweepstakes or credit from a participating merchant for a correct response. In the illustrated embodiment, in step 240, announcement module 120 discounts, waives or otherwise adjusts, for a limited time, the telecommunications service fee normally incurred for connecting calling party 110 to called party 115. For example, system 100 may add 15 minutes of free or discounted calling to any previous allotment.

In step 245, calling party 110 is connected to called party 115 for an allotted time, such as 15 minutes. Step 245 may include monitoring the connection time and comparing the elapsed time to the allotted time.

In step 250, announcement module 120 plays a mid-call message that asks calling party 110 to indicate if he or she would like additional services, such as more minutes, in exchange for listening to another announcement. For example, announcement module 120 may warn calling party 110 that the allotted time is about to expire, such as with approximately one minute remaining. The warning may state that, upon request by calling party 110, the call will be interrupted and that another 15 second advertisement will commence in 45 seconds unless the parties terminate the call. A variety of manifestations of acceptance by calling party 110 may be used, such as by directing calling party 110 to press a button or by speaking a specified word corresponding to an acceptance of the offer. For example, a pre-recorded message may direct calling party 110 to use the keypad, such as by pressing *7, to listen to the next announcement. According to an embodiment, if no response is received, calling party 110 may be billed for the minutes of use beyond the allotted time. In other embodiments, the call may be terminated upon expiration of the allotted time.

After receipt of the acceptance manifestation, announcement module 120 adds time units to the remaining allotted time. The process may continue until the calling parties terminate the connection. In some embodiments, announcement module 120 limits the total number of time units that calling party 110 can receive over a certain time period, such as a maximum of 30 minutes of free or discounted telephone service over a 24-hour period.

Variations, modifications, and other implementations of what is described herein will occur to those of ordinary skill in the art without departing from the spirit and scope of the invention as claimed. Accordingly, the invention is to be defined not by the preceding illustrative description but instead by the spirit and scope of the following claims.

1-27. (canceled)

28. A method for delivering an announcement in a telecommunications system comprising:
maintaining a telephony connection between a calling party and a called party while a remaining earned time allotment is greater than zero;
subtracting time from the remaining earned time allotment while the telephony connection is maintained;
monitoring said telephony connection to determine if the calling party enters a request for an additional promotional message;
in response to detecting the request for an additional promotional message, delivering the additional promotional message to the calling party, wherein the promotional message is selected based on information derived from a financial account associated with the calling party;
soliciting a correct response from the calling party related to the content of promotional message;
adding a time unit to the remaining earned time allotment after receiving the correct response from the calling party; and
terminating said telephony connection when the remaining earned time allotment is zero.

29. (canceled)

30. The method of claim 28 further comprising,
obtaining information about a previous announcement delivered to the calling party.

31. The method of claim 28 further comprising,
limiting the time units the calling party can receive over a certain time period

32. The method of claim 31 wherein limiting includes limiting the calling party to 30 minutes over a 24-hour period.

33. The method of claim 28 further comprising verifying that the message was listened to.

34. The method of claim 33 wherein verifying comprises the steps of:
playing a question about the message; and
receiving a response to the question.

35. The method of claim 28 wherein the announcement is an advertisement.

36. A method for delivering an announcement in a telecommunications system comprising:
receiving information about an identity of a calling party;
retrieving a subscriber profile associated with the calling party, wherein the subscriber profile includes information derived from a stored value or debit account associated with the calling party;
selecting an announcement from a plurality of announcements based on the subscriber profile; and
delivering the announcement to the calling party.

37. The method of claim 36 wherein the announcement is unrelated to a called party.

38. The method of claim 36 further comprising,
receiving control of a call from a telecommunications switch; and
transferring control of the call to the telecommunications switch after delivering the announcement to the calling party.

39. A system for delivering audio announcements comprising:
an interactive voice response system;
a subscriber profile database that includes historical purchasing data associated with a stored value account, wherein the stored value or debit card account is associated with the subscriber;
an advertisement database; and
an announcement module, in communication with the interactive voice response system, the subscriber profile database, and the advertisement database, wherein the announcement module is configured to received an identity of the subscriber from the interactive voice response system, select an advertisement from the advertisement database based on information in the subscriber profile database; and deliver the advertisement to the interactive voice response system.

40. The system of claim 39 wherein the announcement module is configured to receive control of a call from a telecommunications switch.

41. The system of claim 40 wherein the announcement module is configured to return control of the call to the telecommunications switch after delivering the announcement to the calling party.

42. The system of claim 39 wherein the announcement module maintains a log of announcements delivered to the subscriber.

43. The system of claim 39 wherein the subscriber profile database includes at least one of subscriber location, age, gender, call history, and average purchase price over a certain time period.

44. The system of claim 39 wherein the subscriber profile database includes a subscriber purchase history based on merchant category code.

45. The system of claim 44 wherein the subscriber purchase history is derived from a financial card.

46. The system of claim 45 wherein the announcement module is configured to verify the advertisement was listened to.

47. The system of claim 45 wherein the announcement module is configured to play a question about the message and receive a response to the question.
